(19) United States
(12) Patent Application Publication
(10) Pub. No.: US 2004/0241043 A1
(43) Pub. Date: Dec. 2, 2004

(54) Automatic analyzer

(76) Inventor: Stephan Sattler, Starnberg (DE)

Correspondence Address: Roche Diagnostics Corporation, 9115 Hague Road, PO Box 50457, Indianapolis, IN, 46250-0457, US

(21) Appl. No.: 10/804,909

(22) Filed: Mar. 19, 2004

(30) Foreign Application Priority Data
Mar. 19, 2003 (DE) DE 10312197.8

(51) Int. Cl. G01N 35/00

(52) U.S. Cl. 422/64

(57) ABSTRACT

A sample processing instrument and in particular an automatic analyzer is proposed comprising at least one vessel holding device (34) that has a vessel holding zone (32) provided with holder openings (30) to hold sample vessels or reaction vessels (14) wherein at least in the area of the holder openings (30), the surface of the holding zone (32) is formed by a highly electrically conductive material and in particular a material that does not have a tendency to form an electrically insulating passive layer in air and is preferably connected to an electrical reference potential in particular an earth potential. Nickel or a nickel alloy are suitable as the highly electrically conductive material which in particular does not have a tendency to form an insulating passive layer.

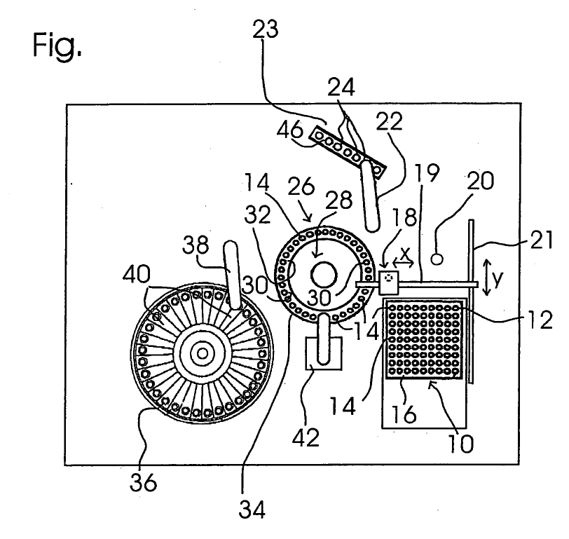

### FIELD OF THE INVENTION

The invention concerns a sample processing instrument, in particular an automatic analyzer with at least one vessel holding device which has a holding zone with holes or recesses for holding vessels such as sample vessels, reaction vessels, reagent vessels, pipette tips, bodies of syringes or suchlike.

### BACKGROUND OF THE INVENTION

A variety of designs are known for such sample processing instruments. Reference is for example made to EP 0 520 304 B1 and EP 1 275 966 A1 of the prior art. The aforementioned documents disclose analytical instruments for the automatic analysis of biological sample material such as blood plasma, serum, urine etc. Such analyzers are often referred to as automated selective multiparameter analyzers based on wet chemistry. When such analyzers are in operation, sample vessels and reaction vessels are transported to removal stations or processing stations on the analyzer using controlled movable X-Y-Z transport mechanisms, pivoted gripping arms and step-wise or continuously rotatable vessel holding rotors as transport means. The processing stations usually comprise pipetting stations for adding samples and reagents to reaction vessels, mixing stations, incubators and reagent and measuring stations. The measuring station for example comprises a photometry station that can be used to carry out luminescence or fluorescence measurements or optical absorption measurements on the sample material to which reagents have been added after analytical reactions between the sample material and the reagents have been completed. Other measuring techniques can also be used to analyse the sample such as the detection of electrochemiluminescence.

These sample processing instruments have at least one vessel holding device which automatically supplies vessels e.g. sample vessels or reaction vessels for carrying out processing steps and removes them again after completion of the processing steps. Such a vessel holding device can for example comprise a rotor disk with a plurality of openings for holding the vessels and can be integrated into an incubator device which is used to thermostat the vessels held in the vessel holding device and their contents at a desired temperature of e.g. 37° C. in order to ensure and facilitate relevant reactions between the sample material and the reagents mixed therewith.

The sample vessels and reaction vessels are usually plastic tubes or glass tubes that are open on one side. The known vessel holding devices are mainly made from aluminium in the area of the holding zones. Aluminium parts are normally anodized as a protection against corrosion.

In a sample processing instrument with such vessel holding zones made of aluminium where the holding zones are automatically loaded with plastic vessels or the plastic vessels are automatically removed from the holding zones, effects have been observed which interfere with the automatic handling and transport of the vessels within the instrument and especially with the positioning of the vessels in the holding zones of the vessel holding devices. Such an effect was that reagent tubes did not readily move into their specified position in the holder holes or were not stable in the specified positions after being lowered into the holder openings of the holding zones of a vessel holding device. The said effects were difficult to reproduce since they depended strongly on the ambient conditions in the laboratory. However, the described effects were occasionally the cause of massive disturbances in the automatic handling of the vessels.

### SUMMARY OF THE INVENTION

The object of the present invention is to provide a sample processing instrument of the aforementioned type in which the automatic handling of the sample vessels is less susceptible to interference than hitherto.

In order to achieve this object, the invention proposes that the surface of the holding zone of the vessel holding device is formed by a material that is a good electrical conductor and in particular does not have a tendency to form an electrically insulating passive layer on contact with air at least in the area of the holes of the holder and is preferably connected to an electrical reference potential and in particular earth potential.

During the development of the sample processing instrument according to the invention it was recognized that the effects that interfere with the automatic handling and positioning of the sample vessels and reaction vessels that are difficult to reproduce are due to the effects of electrostatic forces.

Plastic vessels readily become electrostatically charged for example by frictional electricity during handling and transport. The vessels are often also already electrostatically charged during their manufacture and packaging. With the known sample processing instruments with vessel holding zones made of anodized aluminium the electrically non-conducting eloxal layers also become electrostatically charged in an undefined manner which can result in undesired electrostatic forces between the vessel holding zone and sample vessels and such electrostatic forces make it difficult to position the sample vessels in the holder openings of the vessel holding zones.

However, in the sample processing instrument of the present invention, the surface of the holding zone in the area of the holder openings consists of a material which conducts electricity well and, in particular, does not have a tendency to form an electrically insulating passive layer when exposed to air. Hence the electrical surface resistance is very small in the area of the holding zone so that charge equalization can continuously take place on the surface of the holding zone in the area of the holder openings and the surface can be electrically earthed. Consequently the surface of the holding zone is preferably connected to an electrical reference potential in particular a mass potential i.e. earth potential. The measures proposed by the invention also ensure that the electrical transition resistance between a sample vessel in a holder opening and the surface of the holding zone is small so that charge equalization between sample vessels and the holding zone can occur more effectively than hitherto in order to suppress the said interfering electrostatic effects.

The surface material of the holding zone is preferably nickel or a nickel alloy.

Nickel has proven to be very resistant to corrosion and does not have a tendency to spontaneously form an electrically insulating oxide layer or passive layer in a typical atmosphere for the sample processing instrument under consideration. Thus the good surface conductivity is permanently preserved. It would be possible to make the entire holding zone from nickel but this would be uninteresting for cost reasons.

Rather it is expedient that the holding zone has a base body made of a suitable cheap material that is coated with a surface layer of an electrically highly conductive material that does not have a tendency to form an insulating passive layer, preferably nickel. Aluminium or an aluminium alloy are suitable as materials for the base body and this base body has a nickel surface layer at least in the area of the holder openings for sample vessels manufactured by galvanic nickel plating, chemical nickel plating, nickel plating by a plasma process or/and plating.

The nickel plating produces a highly electrically conductive surface on aluminium and the corrosion resistance of the nickel-plated aluminium components is very good. It costs hardly more to nickel plate aluminium than to anodize aluminium.

Light-weight metals such as magnesium can also be used as materials for the base body. Base bodies made of plastic with a permanent highly conductive surface coating e.g. of nickel can also be used as holder zones according to the invention.

According to a particularly preferred embodiment of the invention the sample processing instrument has an incubator that surrounds the vessel holding device.

Vessel holding zones in mixer stations and measuring stations also preferably have a permanent highly conductive surface which is electrically earthed.

The present invention can also be generalized to include processing instruments in which small plastic components have to be processed and transported. Holding devices with holder openings for such plastic parts would then have to be accordingly nickel plated or provided with a surface of a highly electrically conductive material and in particular a material that does not have a tendency to form an insulating passive layer when exposed to air.

### BRIEF DESCRIPTION OF THE DRAWINGS

The attached figure shows a simplified and partially schematic top view of a fully automatically controlled analytical instrument as an example of a sample processing instrument according to the invention.

### DETAILED DESCRIPTION OF THE INVENTION

The analyzer has a feed station 10 for providing sterile pipette tips 12 and test tubes 14 on a carrier 16. The pipette tips 12 and test tubes 14 provided in an array on the carrier 16 are single-use articles i.e. they are disposed after use.

An X-Y transport mechanism 18 can be moved under the control of a control device along the X rail 19 in the X direction and together with the X rail 19 along the Y rail 21 in the Y direction so that each array position of the carrier 16 can be reached in order to access a pipette tip 12 or a test tube 14 on the carrier 16. A pipette tip 12 is in each case moved to a fitting stand-by position 20 from which it can be engaged by the pipetting arm 22 which has to be positioned appropriately. In the sample uptake position shown in the figure, the pipetting arm 22 can be swung to a sample supply station 23. In the sample uptake position the pipetting arm 22 with the newly attached pipette tip engages in one of the sample vessels 24 supplied in the sample supply station 23 in order to take up a biological sample material located therein.

The X-Y transport mechanism 18 is also used to transport test tubes 14 to a reaction area 26 that has an incubator 28 and to position them there in a holder opening 30 in a circular holding zone 32 of the vessel holder rotor 34 that can be rotated in a step-wise manner.

After swivelling to the reaction area 26, the pipetting arm 22 can add the biological sample material taken up from a corresponding sample container 24 to a test tube 14 which is positioned in a holder opening 30 in the holding zone 32 of the sample holder rotor 34.

A reagent station 36 has a stock of many reagents which can be added selectively to the sample material in the appropriate test tubes 14 in the reaction area 26 in accordance with the analytical program. The swivel-mounted pipetting arm 38 is used to transfer reagents between the reagent area 36 and the reaction area 26. The reagent station is a rotor containing a plurality of reagent vessels 40. Since the reagent rotor 36 can be rotated, each individual reagent vessel can be brought into a position in which it can be reached by the pipetting arm 38 or the pipetting tip located thereon.

A measuring station 42 is provided in the reaction area 26 which can be used to carry out photometric or other measurements on the sample material admixed with reagents.

According to the present invention the holding zone of the sample holding device 34 and the holding area 46 for the sample vessels 24 in the sample supply station 23 are provided with a surface layer of nickel which is electrically earthed. The remaining nickel-plated base body of the vessel holder rotor 34 is made of aluminium.

Interfering effects due to electrostatic forces that were described above can be substantially suppressed with such a highly conductive nickel surface layer. When the test tube 14 is lowered into the openings 30 of the sample holder rotor 34, the test tubes 14 very rapidly find their defined set position i.e. the respective test tubes are no longer displaced from their specified position by electrostatic forces.

As an alternative to nickel, other materials can also be used as permanent highly conductive surface materials for coating vessel holding zones and especially noble metals such as gold, silver and titanium. Chromium can also be used as a material that forms a permanent conductive material on the surface of the holding zones with a low transition resistance.

Within the scope of the invention the term vessel holding device is also intended to include transport devices such as grippers or such like with which the respective vessels come into contact. Thus it is proposed according to the invention that for example vessel contact surfaces of such transport devices also have a permanently conductive surface which is electrically earthed.

What is claimed is:

1. An automatic analyzer comprising a vessel holding device that comprises a holding zone having a surface and provided with a holder opening to hold a vessel, characterized in that the surface of the holding zone comprises an electrically conductive material connected to an electrical reference potential whereby charge equalization is provided on the surface at the holder opening.

2. The analyzer of claim 1, wherein the electrically conductive material is selected from the group consisting of nickel, a nickel alloy, gold, silver, titanium, and chromium.

3. The analyzer of claim 1, wherein the electrically conductive material is nickel or a nickel alloy.

4. The analyzer of claim 1, wherein the holding zone further comprises a base body coated with a surface layer comprising an electrically conductive material.

5. The analyzer of claim 4, wherein the base body is comprised of a material selected from the group consisting of plastic, aluminium, an aluminium alloy, and magnesium.

6. The analyzer of claim 1, wherein the surface is manufactured by a method selected from the group consisting of galvanic nickel plating, chemical nickel plating, and plasma coating.

7. The analyzer of claim 1, further comprising an incubator surrounding the sample holding device.
